(19) United States
(12) Patent Application Publication
(10) Pub. No.: US 2012/0116864 A1
(43) Pub. Date: May 10, 2012

(54) System, Method, and Computer Readable Medium for Improving e-Commerce through Appointment-based Advertisements

(76) Inventors: Reza Jalili, Sandy, UT (US); David Buckland, Park City, UT (US)

(21) Appl. No.: 13/351,725

(22) Filed: Jan. 17, 2012

Related U.S. Application Data
(63) Continuation-in-part of application No. 12/764,906, filed on Apr. 21, 2010.
(60) Provisional application No. 61/172,222, filed on Apr. 24, 2009.
(60) Provisional application No. 61/257,837, filed on Nov. 3, 2009.
(60) Provisional application No. 61/433,907, filed on Jan. 18, 2011.

(51) Int. Cl. G06Q 30/02

(52) U.S. Cl. 705/14.35; 705/14.61

(57) ABSTRACT

A system, method, and non-transitory computer readable medium for enabling the use of an appointment-based electronic ad that restricts or grants access to electronic advertising content based upon an appointed time frame. Access to the restricted advertised content is restricted based upon whether a user is attempting to access the restricted advertised content via an appropriate appointment-based electronic ad and during the appropriate time frame. Furthermore, the system, method, and non-transitory computer readable medium enables the storage, retrieval, sharing, and manipulation of appointment-based electronic ads by an individual user in order to increase the likelihood of their use.

### CLAIM OF PRIORITY

This application is a continuation-in-part of U.S. patent application Ser. No. 12/764, 906, filed Apr. 21, 2010, which claims the benefit of U.S. provisional application Ser. No. 61/172,222, filed Apr. 24, 2009 and U.S. provisional application Ser. No. 61/257,837, filed Nov. 3, 2009. This application also claims the benefit of U.S. provisional patent application Ser. No. 61/433,907, filed Jan. 18, 2011. Each of these applications is incorporated by reference herein, in its entirety, for all purposes.

### FIELD

The present invention generally pertains to processing electronic advertising content and/or other media on an electronic network in order to improve electronic commerce.

### BACKGROUND

Advertising on the Internet involves placing an electronic advertisement, herein referred to as an “electronic ad,” on a Web page or along other digital content in the hope that a consumer will see it. Advertising on the Internet involves an enormous market that has been growing steadily since 1995. Massive sums of money have been spent on advertising on the Internet, including tracking the performance of electronic ads and targeting advertisements to particular audiences using technologies referred to as “targeting technologies.”

An electronic ad includes electronic advertising content and this content is distinct from other forms of electronic content distributed via the Internet. Electronic advertising content is created by a commercial entity in order to drive usage and/or sales of a good or service, herein collectively referred to as “product.” It is not merely content associated with a product, but rather is distributed specifically to generate a benefit (typically a monetary one) for the producer or supplier of the product. For example, an independent review of a product is not electronic advertising content, whereas advertising text distributed by the product manufacturer is electronic advertising content. Additionally, electronic advertising content is subject to advertising laws and regulations, such as truth-in-advertising laws.

An electronic ad may be created so that its distribution may be tracked and evaluated. For example, an electronic ad may include computer code that enables an advertiser to ascertain how many times it has been viewed (e.g., how many “impressions” or “clicks”). Electronic ad tracking may be conducted for financial purposes. For example, an ad provider may charge for ad distribution on a per viewing basis. An advertiser may be responsible for paying the ad provider each time the ad is viewed or fee for a particular amount of viewings.

Generally, electronic advertising works in the following way: a Web site publisher designates space on its Web site as available for advertising. An ad provider provides the publisher with a computer code to be implanted in this ad space. An ad provider is an entity that distributes electronic ads via a network (e.g., the Internet) on behalf of an advertiser, usually for a fee, such as Google AdSense, Yahoo, and the like. An advertiser is an entity wishing to promote a good, service, or the like. When an individual visits a particular page of that publisher's Web site via his web browser, the page is generated per the publisher's source code, while the electronic ad is generated in the ad space per the ad provider's code. The electronic advertising content is retrieved from the ad provider's ad server and fills the ad space on the Web page. The ad server maintains electronic advertising content, typically configured by the ad provider on behalf of an advertiser. Each time a visitor visits a Web page, a new set of electronic ads may be displayed because the site publisher may have business relationships with more than one ad provider or because the same ad provider may choose a different set of electronic ads to show on the Web page. Furthermore, the electronic ad code itself may specify various ads to be shown in the ad space and the ad displayed may vary per the user's particular visit to the Web page. A user may select an electronic ad, such as by clicking it, and his web browser typically is directed to present a landing page associated with the advertiser. The landing page is typically the advertiser's main Web page. For example, a user selecting an electronic ad for a dating service will be presented with the dating service's home page. When a user clicks on an electronic ad, his attention to his previous task is interrupted. With the browser navigating to the ad's landing page, the user's attention is diverted.

As systems evolve to allow for the time-shifting of electronic ads and the storage of electronic ads by users for later engagement, new opportunities arise for new advertising possibilities.

Advertisers aim to obtain the full attention of users on the product being presented via an electronic ad and, as such, advertisers need one or more engagement mechanisms to do so.

Therefore, an engagement mechanism is needed to engage consumers interested in an advertised product.

### SUMMARY

The present invention addresses the aforementioned needs by providing a system, method, and non-transitory computer readable medium for enabling the use of an appointment-based electronic ad that restricts or grants access to advertised content based upon an appointed time frame. Access to the restricted advertised content is restricted based upon whether a user is attempting to access the restricted advertised content via an appropriate appointment-based electronic ad and during the appropriate time frame. Furthermore, the present invention enables the storage, retrieval, sharing, and manipulation of appointment-based electronic ads by an individual user in order to increase the likelihood of their use.

### BRIEF DESCRIPTION OF THE DRAWINGS

In order to describe the manner in which the above-recited and other advantages and features of the invention may be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a general architecture overview of an embodiment of a personal advertisement storage system;

FIG. 2 illustrates an embodiment of a personal advertisement storage system server;

FIG. 3 illustrates a flowchart of an embodiment of a process for accessing a stored electronic advertisement from an ad server;

FIG. 4 illustrates a flowchart of an embodiment of a process for accessing a stored electronic advertisement from an ad server via a personal advertisement storage system server;

FIG. 5 illustrates a flowchart of an embodiment of a process for accessing a stored electronic advertisement from a personal advertisement storage system server;

FIG. 6 illustrates a flowchart of an embodiment of a process for storing an electronic advertisement at a personal advertisement storage system server;

FIG. 7 illustrates a flowchart of an embodiment of a process for storing an electronic advertisement via an ad server;

FIG. 8 illustrates a schematic embodiment of an electronic appointment ad; and

FIG. 9. illustrates a flowchart of an embodiment of a process for accessing electronic advertising content via an electronic appointment ad.

### DESCRIPTION OF EMBODIMENTS

Various embodiments of the invention are discussed in detail below. While specific implementations are discussed, it should be understood that this is done for illustration purposes only. A person with ordinary skill in the relevant art will recognize that other components and configurations may be used without parting from the spirit and scope of the invention.

The present invention is described herein mainly in terms of an individual accessing the Internet, such as via a personal computer, a mobile phone, a personal electronic assistant, or a multipurpose mobile device (e.g., an iPhone, a Blackberry, etc.). This is not to be construed as limiting as the present invention may be applicable to any electronic network accessible to a user via a network-appropriate device. For example, the present invention may be applied to broadcast networks (e.g., cable, satellite, etc.), mobile networks, interactive television systems, kiosk systems, and any technologies that enable the electronic display of advertisements.

Personal Advertisement Storage Network (PASS)

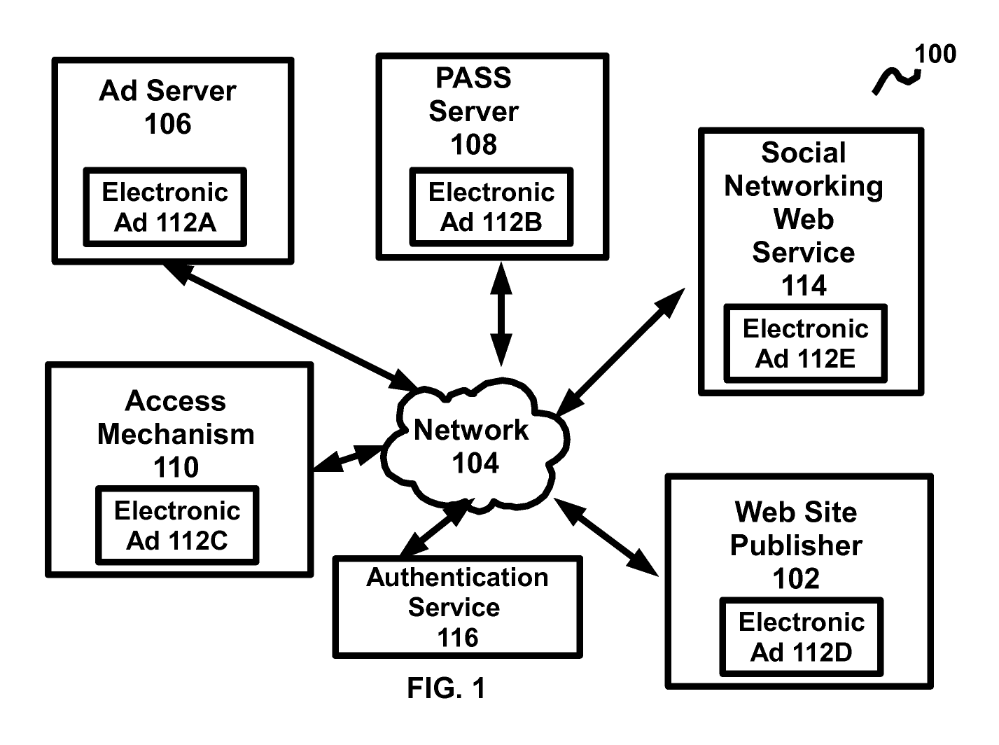

As illustrated by FIG. 1, the present invention pertains to personal advertisement storage system (PASS) 100. PASS 100 components are herein referenced

as “systems,” “servers,” “services,” “mechanisms,” etc., but this is not to be construed as limiting and it is to be understood that each component may include the necessary hardware, firmware, and/or software to enable functionality and the processing, storing, communicating and/or receiving of data. For example, a component may include one or more computer processors, computer servers, data stores, electronic components, storage mediums, memory, etc. Although only a single instance of each component is depicted, this is for illustrative purposes only and is not to be construed as limiting. Furthermore, although each component is depicted and described herein as separate, this is not to be construed as limiting, and components may be combined per implementation. For example, PASS server 108 and ad server 106 may be combined into one component and/or be maintained by the same entity or affiliated entities. PASS 100 may include one or more ad servers 106, PASS servers 108, and Web site publishers 102. Ad server 106 may be maintained by an ad entity, which may be an organization or individual that distributes electronic ads and its ad server 106 may maintain its electronic advertising content. For example, an ad entity may be an ad provider (e.g., Google AdSense), an advertising agency, an individual advertiser, a newspaper (e.g., with classified ads), or the like. PASS 100 may also comprise one or more social networking Web services 114 and/or one or more authentication services 116. A user may interact with PASS 100 via access mechanism 110 and access mechanism 110 may enable the user to access data from ad server 106 or PASS server 108. Access mechanism 110 may be a combination of software and hardware configured to enable the viewing and the inputting of information by the user. For example, a user may access PASS 100 by loading a Web page on his personal computer via a web browser, such as Microsoft Internet Explorer or Mozilla Firefox, or through his mobile device via its browsing application. Additionally, a user may access PASS 100 via other properly equipped devices, such as televisions, kiosks, or other presentation systems. Furthermore, PASS 100 may be accessible via various embodiments of access mechanism 110 and a user may employ any combination of these device types. For example, a user may store an electronic ad via his mobile phone and later access it via his television. The components of the system may interact with one another via network 104, which may be an applicable electronic network, such as the Internet or a mobile network.

The term “electronic ad” is not to be construed as limiting and may pertain to electronic data associated with an advertisement in various forms as would be appropriate to the related system component. For example, in relation to ad server 106, PASS server 108, Web site publisher 102, or social networking Web service 114, an electronic ad (e.g., electronic ad 112A, electronic ad 112B, electronic ad 112D, and electronic ad 112E, respectively) may pertain to a data record and/or computer code. In relation to access mechanism 110, an electronic ad (e.g., electronic ad 112C) may pertain to a visual representation of an advertisement along with other data, such as a link. An electronic ad may include a video, an image, textual data, or any other advertising mechanism. An electronic ad may include data indicative of a particular item for sale, such as an item offered at eBay.com, Amazon.com, or the like.

PASS Link

To participate in PASS 100, an ad entity may embed a PASS link in an electronic ad when creating it (i.e., electronic ad 112A). The PASS link may encode information about electronic ad 112A and the URL of PASS Server 108. An ad entity may also modify existing ads to include a PASS link. The PASS link may be configured to be displayed as a PASS icon in proximity to the actual electronic advertising content. The PASS link may be computer code, such as JavaScript code, an HTML link, or similar mechanism, to instruct access mechanism 110 to perform a certain set of operations other than what may be construed as a click-through. Once an electronic ad includes a PASS link, it may be considered “PASS-enabled” and may enable the electronic ad to be stored with minimal manual human action. In one embodiment, as will be described below, a PASS-enabled electronic ad enables the electronic advertising content to be associated with the user at ad server 106 instead of, or in addition to, be stored in association with user at PASS server 108.

After the inclusion of a PASS link in electronic ad 112A, electronic ad 112A is enabled for storage if a user so chooses and may be distributed via standard methods. For example, when accessing a Web page, access mechanism 110 may display electronic ad 112A as electronic ad 112C by requesting the necessary data from ad server 106 and formatting it accordingly. In an alternative implementation, access mechanism 110 may retrieve the ad data via PASS server 108 (i.e., from electronic ad 112B). For example, the ad request may be sent directly to PASS server 108 instead of to ad server 106. PASS server 108 may retrieve the electronic ad 112A from ad server 106, configure it via configuration mechanism 214 to include the necessary PASS link information and, optionally, other user interface elements, and then distribute the PASS-enabled electronic ad 112B to access mechanism 110, which may display it as electronic ad 112C. Because PASS server 108 may carry out the embedding of PASS link, this implementation may necessitate no additional effort on the part of an ad entity. In another embodiment, Web site publisher 102 may configure a Web page to enable the inclusion of a PASS link in an electronic ad 112D it displays. For example, Web publisher 102 may enable the ad slots of its Web page to configure displayed electronic ads 112D as PASS-enabled electronic ads automatically by way of configuring its ad slots to capture the electronic ad served by ad server 106 and to provide user-interface elements within the ad slot or elsewhere to allow for the transmission and storage of the electronic ad; that is, to allow for PASS link information to be associated with the electronic ad served into the ad slot by ad server 106. In another embodiment, access mechanism 110 may be enabled to embed a PASS link in an electronic ad it displays (i.e., electronic ad 112C). For example, access mechanism 110 may detect the presence of one or more ad slots on a Web page it is presenting and may be configured to display the associated electronic ads 112C as PASS-enabled electronic ads automatically. In one embodiment, access mechanism 110 may be enabled to configure electronic ads 112C as PASS-enabled via a browser extension or “add-on.”

Stored Electronic Ad

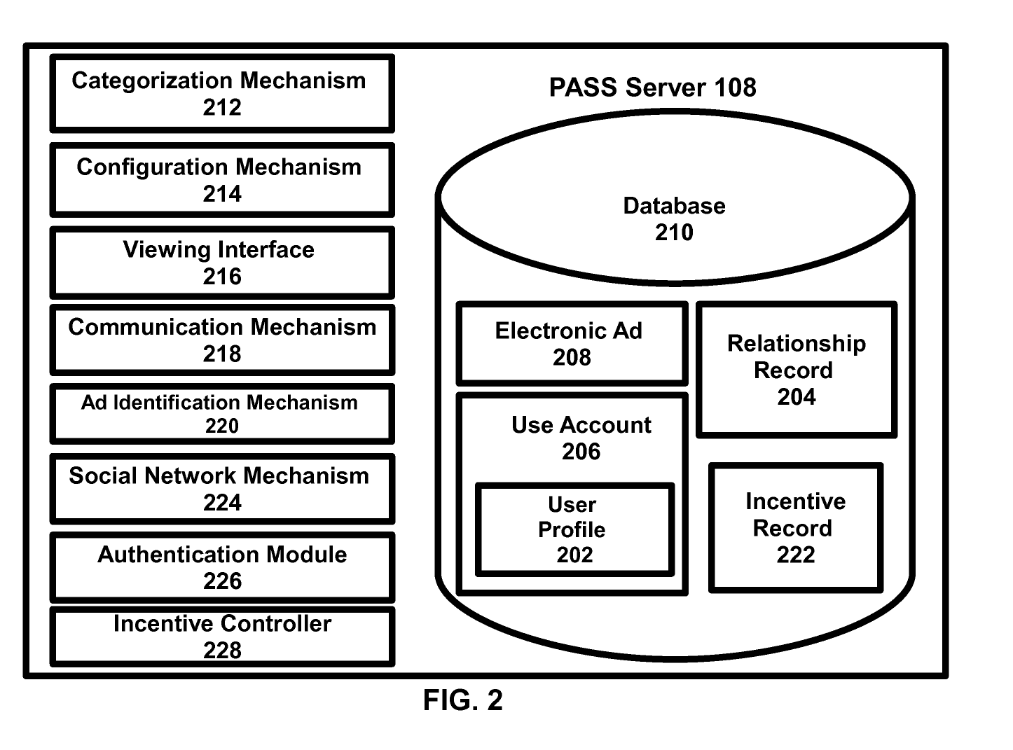

As illustrated by FIG. 2, PASS server 108 may include one or more databases 210 that securely maintain electronic ads 208 stored by users so that these ads may be accessed at a later time. Storing an electronic ad may involve storing data related to the ad in database 210 in such a way that a user may view the stored electronic ad 208 as it was originally presented. For example, if an electronic ad includes a video involving a product offer, the user may store this electronic ad and later view the video when accessing the stored ad. PASS server 108 may transmit ad usage data to ad server 106 so that it may determine how many times the stored electronic ad 208 has been viewed. A user's use of an electronic ad is described as “viewing,” but this is not to be construed as limiting. “Viewing” of an electronic ad as used herein pertains to an ad impression, a user clicking on the electronic ad, and the like.

In one embodiment, a stored electronic ad 208 may include one or more of tracking information associated with the electronic ad, such as the referral location (e.g., information about the Web site at which the user viewed the electronic ad) and its Uniform Resource Location (URL). In order to avoid possible formatting and display problems, the entire code associated with the electronic ad may be retrieved from ad server 106 and included with stored electronic ad 208.

In another embodiment, a stored electronic ad 208 need not include one or more of the aforementioned elements. When PASS server 108 receives an indication that a user wishes to store an electronic ad, ad identification mechanism 220 may establish an ad identifier for the ad and this ad identifier may be included with the stored electronic ad 208. For example, ad identification mechanism 220 may assign it an alphanumeric identifier. By assigning an ad identifier, PASS server 108 does not need to store all information associated with the electronic ad, some of which may be proprietary to the ad entity. Not storing the entire electronic ad information may reduce the burden of PASS server 108 and may allow ad server 106 to maintain complete control over the ad entity's electronic ads. In one scenario, the stored electronic ad 208 only includes the ad identifier. Alternatively, the ad entity may generate an ad identifier for its electronic content. When publishing an electronic ad, the ad entity may assign it an ad identifier, include it in an embedded PASS link, and publish the ad identifier (i.e., via the PASS link) in association with the electronic ad. The ad identifier may be transmitted to PASS server 108 when the user indicates he wishes to store the associated electronic ad (e.g., by clicking the PASS icon). In an alternative embodiment, the ad entity may register an ad identifier with PASS server 108 when it publishes an electronic ad so that PASS server 108 may maintain a searchable registry of storable electronic ads.

If an ad identifier, rather than the complete ad code, is employed for storage, one or more processes may be employed by PASS server 108 to present the stored electronic ad 208 via access mechanism 110. An ad identifier may serve as a reference for ad retrieval data within PASS server 108. Once a particular stored ad is selected for viewing, the PASS server 108 may locate ad retrieval data, such as a computer code, associated with its ad identifier. In one embodiment, PASS server 108 may share the ad identifier with ad server 106 so that ad server 106 may associate it with the appropriate ad in its own records. This may assist in determining the appropriate electronic advertising content at ad server 106 when user wishes to view the stored electronic ad 208.

As described herein, unless explicitly noted, a stored electronic ad may pertain to any of the aforementioned embodiments.

User Data

Database 210 may also maintain a user accounts 206 for each user. Although electronic ads are described herein as being stored in a user account 206, this is not to be construed as limiting. In one embodiment, rather than being stored in a particular user account 206, an electronic ad may be maintained separately at PASS server 108, but may be associated with a user account 206 via a user identifier or similar mechanism. For example, electronic ads may be associated with an individual's email address, username, identification code, or the like. A user account 206 also may include a user profile 202 which may include credential information (e.g., username and password), personal information, demographic data, financial account data, and the like. Database 210 may also maintain a relationship record 204 which may include data pertaining to how particular users and ad entities are related to other users and ad entities. For example, relationship record 204 may indicate which users an individual has listed as friends or which users have stored ads for a particular ad entity. PASS server 108 may also include communication mechanism 218 which may enable PASS server 108 to interact with other entities attached to network 104, such as ad server 106 and access mechanism 110. PASS server 108 may, in addition to, or instead of a relationship record 204, include a social network mechanism 224, such as an application programming interface (API), thereby enabling interaction with a social networking Web service 114, such as Facebook. One or more elements of relationship information and user profile data may be stored in association with the user's social network account in addition to, or instead of, being associated with a user account 206 at PASS server 108.

Electronic Ad Storing

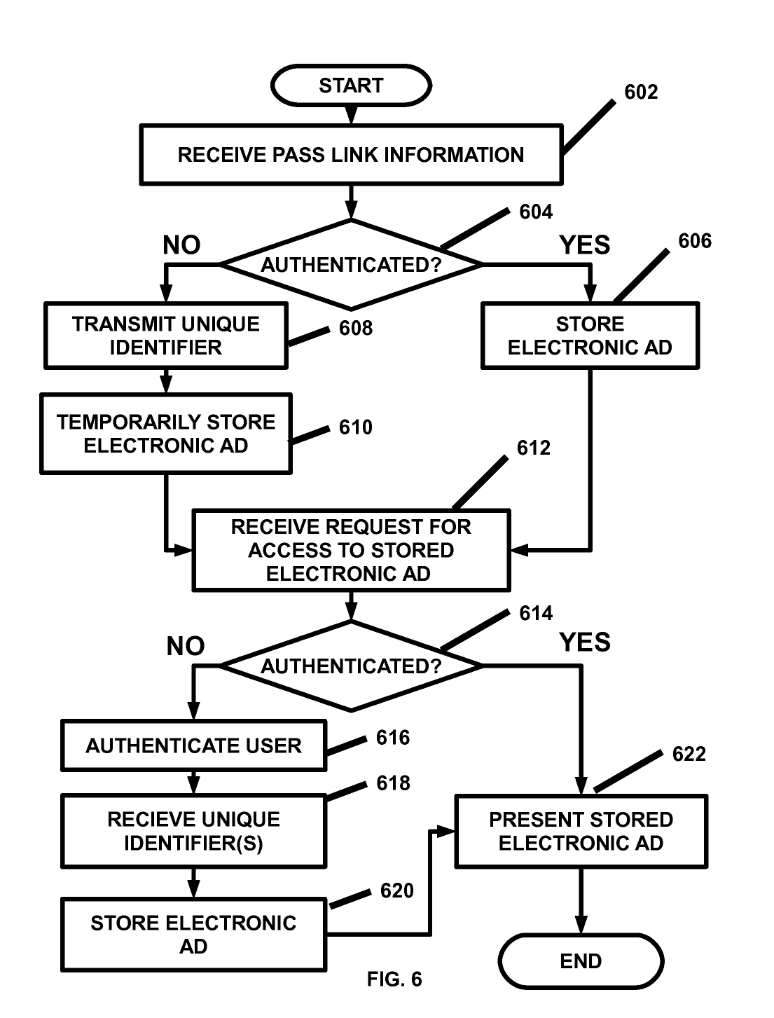

FIG. 6 illustrates a flowchart of an embodiment of a process for storing an electronic ad at PASS 108. As a user interacts with a Web page, he may be presented with a PASS-enabled electronic ad. If the user wishes to save the electronic ad for later viewing, he may select the PASS icon, such as by clicking it with a mouse. In an alternate embodiment, when the electronic ad is selected, an electronic form may become visible, overlaid on the electronic ad, presenting the user with two options: go to the ad landing page or to store the electronic ad such that there is no further distraction from the current Internet activity of the user. For example, when a user sees an electronic ad on a Web site, he may bring his mouse pointer over the ad and an overlay may be shown on the ad with a clickable prompt stating “go there now” and another clickable prompt stating “save for later.” The user may click “save for later,” and JavaScript code associated with the PASS-enabled electronic ad may be executed by access mechanism 110, causing a message to be sent to PASS server 108 with encoded ad information. PASS server 108 may receive PASS link information (e.g., the URL and encoded ad information and/or the ad identifier) (step 602). Authentication module 226 may determine if the user has been authenticated (step 604). If so, authentication module 226 analyzes the user's credentials in order to associate the electronic ad with the appropriate user account 206, thereby storing it (step 606). As aforementioned, when a user opts to store an electronic ad, ad identification mechanism 220 may associate an ad identifier with the stored electronic ad 208. Ad identification mechanism 208 may generate the ad identifier or, if an ad identifier was included with the received PASS link information, ad identification mechanism 208 may use it. In one embodiment, PASS server 108 may communicate the ad identifier to ad server 106, which may in turn associate the ad identifier with the electronic ad in its own database. This may be unnecessary if the ad entity has already associated an ad identifier with the electronic ad. Any known method may be employed to authenticate the user and identify his user account 206. For example, a user's credentials may be a tracking cookie or a username and password. In one embodiment, if the user has not been authenticated, he may be prompted to do so upon initiating electronic ad storage. Alternatively, as depicted in FIG. 6, to avoid burdening the user with authentication processes at the time of storage, PASS server 108 may transmit a unique identifier to access mechanism 110, such as a cookie or similar mechanism (step 608). PASS server 108 may then store the received PASS link information temporarily in association with the unique identifier (step 610). When PASS server 108 subsequently receives a request for access to the stored electronic ad 208 from access mechanism 110 (step 612), authentication module 226 may again determine if the user has been authenticated (step 614). If so, the stored electronic ad 208 may be presented (step 622). If the user has not been authenticated, authentication module 226 may prompt the user for authentication credentials and the user may be authenticated (step 616). PASS server 108 may then receive one or more unique identifiers previously provided to access mechanism 110 (step 618), store the associated electronic ads 208 in association with the appropriate user account 206 (step 620), and present the stored electronic ad 208 (step 622). Alternatively, rather than requiring the user to ever actively authenticate himself, PASS server 108 may utilize the unique identifiers received from access mechanism 110 completely for the storage, retrieval, and presentation of a stored electronic ad 208.

In another embodiment, PASS 100 may include authentication service 116 and authentication service 116 may authenticate users on behalf of PASS server 108, rather than PASS server 108 itself. In one embodiment, a user may store an electronic ad in association with one or more of his PASS user account 206 and his social network Web service 114 account by way of social network mechanism 224. Social network Web service 114 may handle user authentication instead of, or in addition to, PASS server 108 or authentication service 114. In one embodiment, PASS server 108 interfaces with Facebook, Google, and/or other popular social networks, such that for the majority of users for the majority of the time, no prompting of user credentials is necessary when the user is already logged into one of those other services using access mechanism 110.

In one scenario, a software application may ease use of PASS 100. For example, an “add-on” for a web browser and/or a Web service may enable functionality that eases the storage of electronic ads to PASS server 108, allowing a user to store one or more electronic ads displayed to the appropriate user account 206. The electronic ads still may be shown as the user employs access mechanism 110 or they may be suppressed until the user accesses PASS server 108 to view them.

Electronic Ad Sharing

PASS 100 may also enable various viral marketing methods, such as the sharing of stored electronic ads. A user may be enabled to share a stored electronic ad 208 with other individuals. This may be done through PASS server 108 (i.e., from one PASS user to another) or PASS server 108 may interact with another service, such as a social networking Web service 114 (e.g., Facebook.com, MySpace.com, etc.), so that a user may share a stored electronic ad 208 with other users of the social networking Web service 114. As aforementioned, social network mechanism 224 may enable PASS server 108, and in turn the user, to view, store, and share electronic ads via a social networking Web service 114. In one embodiment, PASS server 108 itself may serve as a social networking Web service and users may see which stored electronic ads 208 other users have shared. Alternatively, a user may be enabled to share a stored electronic ad 208 via email, such as by emailing a link to the stored ad. A user may be required to have authorization by another user to be privy to shared electronic ads. For example, an individual's shared, stored electronic ads 208 may only be visible to other users the individual has indicated are friends. To encourage users to share stored electronic ads 208, an ad entity or the PASS service provider may compensate a user for sharing. A user may be required to share a minimum amount before being compensated and/or a user may be limited to sharing a maximum number for a particular period (e.g., 100 ads per month). Once a user has shared a stored electronic ad 208, it may be associated with both initial user and the recipient. A first user who shares an ad that is subsequently deleted by a recipient second user may get negative points which when accumulated may indicate that the first user is abusing the sharing mechanism and should be blocked or have her ability to share ads limited. This feedback mechanism is important to reduce the spam effect.

Viewing and Managing Stored Electronic Ads

After an electronic ad has been stored in association with user account 206, the user may access PASS server 108 to view it. An electronic ad may be considered stored in (i.e., associated with) an individual's user account 206 if the individual stored it, if another PASS user shared it with the individual, or if the individual's profile settings allow PASS server 108 to store the electronic ad in his user account 206 automatically. Viewing interface 216 may enable the presentation of the stored electronic ads regardless of who stored the ad or may present only electronic ads stored by a certain set of users. For example, thumbnail images representative of stored electronic ads may be presented. While a user may have a personal set of stored electronic ads (e.g., those he has stored or those he has received via sharing), he may also be able to access the stored electronic ads of other users. A user may be allowed to designate which of his stored electronic ads are public and which are private.

The user may access PASS server 108 in various manners. For example, a user may access PASS server 108 by accessing a Web site, using a keyboard combination, or by right clicking on a PASS icon displayed on an electronic ad, thereby accessing a menu with a link to access PASS server 108. Once PASS server 108 is accessed, the user may provide credentials. Alternatively, a user need not identify himself to view electronic ads stored publicly. When accessing PASS server 108, the user may be redirected to a PASS Web site or the user may remain at his current Web site and view the stored electronic ads 208 in an existing ad slot at the current Web page, on a pop-up screen, as an overlay on the current Web page, or the like. As aforementioned, PASS server 108 may interact with social networking Web service 114 and, as such, a user may be enabled to view, share, and manage stored electronic ads 208 via an interface at social networking Web service 114. Stored electronic ads 208 may be presented in the order in which they were stored, for example, displaying the first stored ad at the top or bottom of a list. In one implementation, participating ad entities may affect the presentation order of stored electronic ads 208. For example, an ad provider or advertiser may compensate the PASS service provider in order to have its ad presented advantageously. Additionally, the user may be enabled to sort his stored electronic ads 208 as he wishes, such as by date saved, title, and the like.

The user may select a stored electronic ad 208 to view it. Selecting a stored electronic ad 208 may load the ad per the stored data. The user need not log into or have access to the Web page where the ad was originally displayed as pertinent information and/or an ad identifier has been recorded at PASS server 108. The particulars of presenting a stored electronic ad 208 may vary per implementation. The viewing of a stored electronic ad 208 may be similar to the initial viewing of the electronic ad 112D at a Web page. When a user views a Web page, Web site publisher 102 may request the electronic advertising content (e.g., electronic ad 112A) from ad server 106 and may present it in an appropriate space on the Web page (i.e., an “ad slot”). In one scenario, the requested advertising content may be relayed through PASS server 108, such as if the content has not been PASS-enabled by ad server 106, so that it may be PASS-enabled by PASS server 108. When a user accesses PASS server 108 to view a stored electronic ad 208, PASS server 108 may serve as a publisher and present the stored electronic ad in a similar fashion, such as by requesting the electronic advertising content from ad server 106.

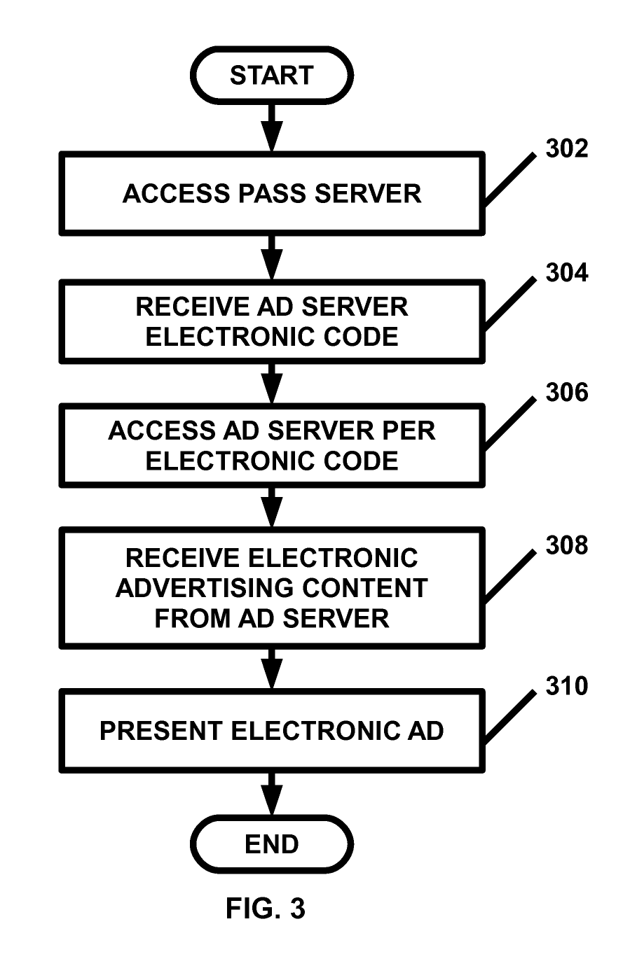

As illustrated by FIG. 3, in one embodiment, the user may employ access mechanism 110 to access PASS server 108 to view a stored electronic ad 208 (step 302). Access mechanism 110 may receive computer code which may include the original ad server ad code (or code sufficiently similar) (step 304) and may employ it to access the ad server 106 (step 306). Access mechanism 110 may then receive the appropriate electronic advertising content from ad server 106 (step 308) and present the electronic ad to the user (step 310). In one scenario, PASS server 108 may provide access mechanism 110 with the same ad code used at the Web page from which the user stored the electronic ad 208, thereby functioning in a fashion similar to the originating Web page. For example, the retrieved computer code may indicate the stored electronic ad is provided by the Google ad server and the user's web browser may access the Google ad server to retrieve it. An ad identifier previously assigned to the stored electronic ad 208 by ad identification mechanism 220 may be used to assist with this process. The computer code provided to access mechanism 110 may include the ad identifier and access mechanism 110 may relay this to ad server 106 so that ad server 106 may employ it to locate the appropriate electronic advertising content in its records.

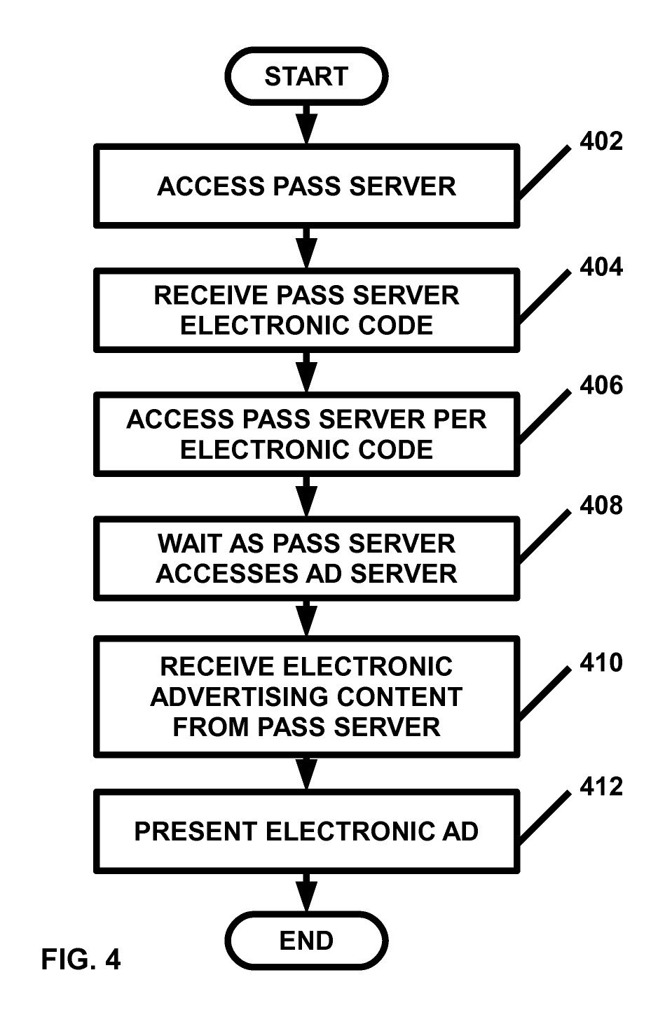

As illustrated by FIG. 4, in another embodiment, when access mechanism 110 accesses PASS server 108 (step 402), it may receive computer code that instructs access mechanism 110 to access PASS server 108 itself (step 404). When access mechanism 110 accesses PASS server 108 per this code (step 406), it may wait as PASS server 108 accesses ad server 106 to retrieve the electronic advertising content (step 408). Once PASS server 108 has retrieved the necessary content, access mechanism 110 may receive it (step 410) and present the electronic ad to the user (step 412). For example, when access mechanism 110 accesses the stored electronic ad 208, the received computer code (e.g., HTML snippet data) may include a link (e.g., a URL) to PASS server 108, rather than ad server 106, and PASS server 108 may then employ the computer code to determine the proper ad server 106 from which to receive the electronic ad. An ad identifier may assist with this process as well. For example, the computer code sent to access mechanism 110 from PASS server 108 may include the ad identifier and PASS server 108 may employ this to determine the proper ad server 106. In one embodiment, if ad server 106 has also associated the ad identifier with the electronic ad in its own records, PASS server 108 may employ relay the ad identifier to ad server 106 in order to assist in the retrieval of the necessary electronic advertising content. In one scenario, PASS server 108 only transmits the ad identifier to ad server 106 for electronic ad retrieval. Because the electronic advertising content passes through PASS server 108, PASS server 108 may be enabled to modify the stored electronic ad.

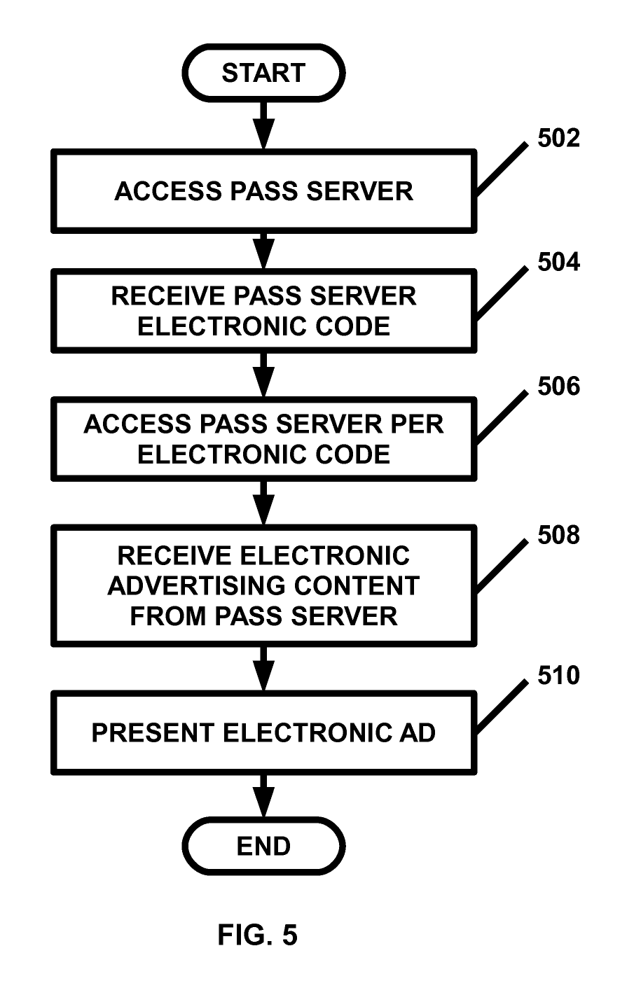

As illustrated by FIG. 5, in another embodiment, if the stored electronic ad 208 includes all the necessary electronic advertising content, ad server 106 need not be accessed by access mechanism 110 or PASS server 108. When access mechanism 110 accesses PASS server 108 (step 502), it may receive computer code that instructs access mechanism 110 to access PASS server 108 itself (step 504). An ad identifier may be used to assist in locating the proper stored electronic ad. When access mechanism 110 accesses PASS server 108 per this code (step 506), access mechanism 110 may receive the electronic advertising content (step 508) and present the electronic ad to the user (step 510). For example, PASS server 108 may pre-generate the code (e.g., HTML) so that access mechanism 110 may display the electronic ad based solely on the rendering instructions PASS server 108 provides access mechanism 110.

Stored electronic ads may be optimized upon presentation to increase overall advertising effectiveness. As aforementioned, because the request to view the stored electronic ad 208 involves PASS server 108, PASS server 108 may be enabled to modify the stored electronic ad 208 when it is displayed. Ads from one advertising entity or from a set of advertising entities may be optimized such that each ad is more attractive to the user or the set of ads together are more attractive to the user. The advertising entity need not rely on ad server 106 to enhance the stored electronic ad 208. For example, if the user has stored an ad for a chair and an ad for a table, PASS server 108 may retrieve and display a bonus ad for a set of dishes, a table cloth, or a discount for buying both the table and the chairs. PASS server 108 may display such ad combinations even if the ads are from different advertising entities. An advertising entity associated with an electronic ad may pay the PASS service provider a fee so that an additional electronic ad is presented whenever a particular electronic ad is presented. If a second advertising entity is paying for this service, the second advertising entity may request to have his electronic ad presented more prominently than the ad of the first advertising entity.

Ads stored at the PASS server 108 may be associated with one or more categories. For example, an electronic ad for beer may be categorized as “beer,” “drink,” and/or “alcohol.” When a user accesses his user account 206, his stored ads may be displayed as grouped by category. Ad categorization may be handled by the ad entity, the user, a PASS service provider, categorization mechanism 212, or a combination thereof. For example, an ad entity may associate data with an ad that indicates one or more proper PASS categories. The user may log into his user account 206 and categorize his stored ads as he wishes. For example, a user may “tag” the stored beer ad as “funny” or “beer.” Categorization mechanism 212 may categorize ads based on information provided by ad entities and/or users, or it may analyze ad content and categorize electronic ads appropriately.

Electronic Ad Storing and Viewing Via an Ad Server

In one embodiment, when a PASS-enabled electronic ad is displayed via access mechanism 110, data may be relayed through ad server 106. By relaying such data through ad sever 106, ad server 106 may log which electronic ads have been stored at PASS server 108 in addition to recording whether an electronic ad has been viewed.

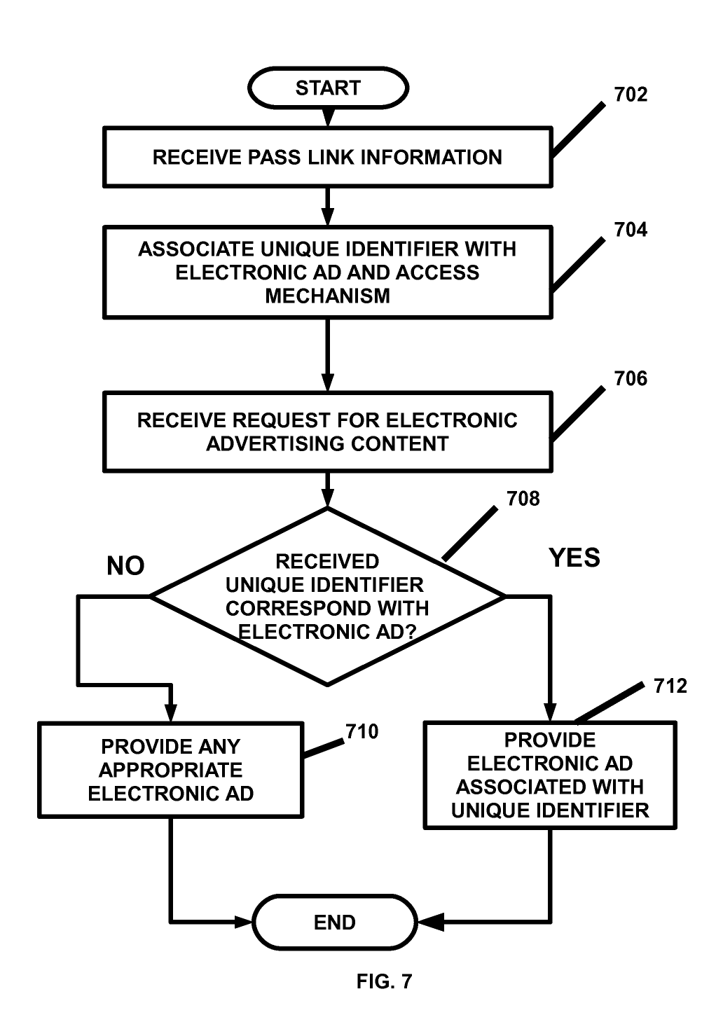

As depicted by FIG. 7, a PASS-enabled electronic ad may be configured to associate an electronic ad with the user at ad server 106 instead of, or in addition to, storing it at PASS server 108. In such an embodiment, a PASS-enabled electronic ad may be associated with access mechanism 110 at ad server 106 via the use of a unique identifier (e.g., a cookie). A user may employ access mechanism 110 to view a Web page maintained by Web site publisher 102 and Web site publisher 102 may retrieve one more electronic ads from ad server 106 to present to the user. When a user views a PASS-enabled electronic ad he would like to view later, he may indicate this, and ad server 106 may receive PASS link information (step 702). In one scenario, the PASS-enabled electronic ad may provide the user with an interface so that he may specify when he would like to view the electronic ad. For example, a user may be presented with a drop down menu and he may select whether he wishes to view the electronic ad in an hour, a day, at specific date and/or time, or the like. After receiving PASS link information, ad server 106 may associate a unique identifier with access mechanism 110 and with the appropriate electronic advertising content in its own database, thereby associating it with access mechanism 110 (step 704). Ad server 106 may associate the unique with access mechanism by transmitting it to access mechanism 110 when the user indicates he wishes to view the electronic ad later or ad server 106 may employ a unique identifier already present at access mechanism 110. For example, ad server 106 may automatically transmit a tracking cookie to access mechanism 110 when it accesses a Web site containing its electronic ads, regardless of whether the user has opted to view an electronic ad later. An electronic ad associated with access mechanism 110 in this fashion may be presented to the user whenever access mechanism 110 accesses a Web site configured to display electronic ads from ad server 106, regardless of whether the Web site publisher 102 is the same as the Web site publisher 102 involved in the initial display of the electronic ad. When access mechanism 110 subsequently accesses a Web page, ad server 106 may receive a request for electronic advertising content from the Web site publisher 102 and this request may include one or more unique identifiers associated with access mechanism 110 (step 706). Ad server 106 may determine if a received unique identifier corresponds with a unique identifier associated an electronic ads (step 708). If not, ad server 106 may provide any electronic ad deemed appropriate (step 710). If ad server 106 determines that an electronic ad is associated with access mechanism 110 via a unique identifier, it may provide the corresponding electronic ad (step 712). Ad server 106 may acquire data regarding which electronic ads interest the user in addition to increasing the chances that the user will view the electronic ad at one point. This particular electronic ad procedure allows a user to indicate interest in an electronic ad and delay its viewing without the need to access PASS server 108. One may view this procedure as enabling a user to indicate he would like to be reminded of the electronic ad at subsequent, more convenient time. This procedure requires less action on the part of the user, as he need not take explicit action to view the electronic ad later. That is, he may be presented with the electronic ad when he subsequently accesses one of a plurality of Web sites and need not access PASS server 108.

The aforementioned process need not involve PASS server 108 and therefore PASS server 108 may be omitted in such an implementation. In another embodiment, when ad server 108 receives an indication that user wishes to view an electronic ad later, in addition to associating a unique identifier with the electronic ad and access mechanism 110, ad server 110 may transmit this unique identifier to PASS server 108. PASS server 108 may store the unique identifier in a temporary record. If access mechanism 110 later accesses PASS server 108, PASS server 108 may obtain one or more unique identifiers from access mechanism 110, determine if it has stored any electronic ads in association with the received unique identifiers and store them in association the appropriate user account 206. Depending upon the embodiment, PASS server 108 may store all of the necessary electronic advertising content or may store data sufficient to retrieve the electronic advertising content from ad server 106 (e.g., an ad identifier). As previously described, PASS server 108 may serve as the publisher and present the stored electronic ad 208 via access mechanism 110.

Accounting for Electronic Ad Storage, Viewing, and Actions

PASS server 108 may interact with the ad server 106, and another authorized third-party, to enable proper tracking of stored electronic ads, click-through rate, and any associated payment (e.g., royalties, etc.). For example, PASS server 108 may share viewing data with the account manager of an ad agency or a third-party analytics server that charts and creates further statistics from the data. PASS server 108 may record each viewing of a stored electronic ad in a viewing log. This functionality may be enabled by an accounting mechanism, such as an API, to which any ad server 106 from a participating advertising serving network may connect. Electronic ads may operate via various budgeting schemes and, therefore, specific accounting processes may be necessary in order to ensure accurate accounting of an electronic ad stored and/or shared via PASS 100. The accounting process employed may be associated with the method of electronic ad storage and/or display. If the presentation of a stored electronic ad 208 is handled in a fashion similar to an electronic ad displayed at a Web page (i.e., the electronic advertising content is retrieved from ad server 106), as illustrated by FIG. 3, ad server 106 may treat the viewing of a stored electronic ad 208 in the same manner as an ad presented on a standard Web page. If all of the data necessary for displaying a stored electronic ad 208 has been stored at PASS server 108, as discussed in relation to FIG. 5, access mechanism 110 may interface solely with PASS server 108 to display a stored electronic ad 208, and therefore PASS server 108 may maintain a viewing log for a stored electronic ad 208 and relay this viewing data to ad server 106, instantly, periodically, or the like. If the display of the stored electronic ad 208 requires PASS server 108 to serve as an intermediary between access mechanism 110 and ad sever 106, as depicted by FIG. 4, one or more of PASS server 108 and ad server 106 may track the viewing of a stored electronic ads 208.

PASS server 108 may enable the analysis of stored electronic ads 208 in order to ascertain ad usage, such as viewings (e.g., “impressions,” “clicks,” etc.). In particular, PASS sever 108 may determine which electronic ads have been stored and/or shared but have not yet been viewed by the associated user(s). As such, PASS server 108 may provide an ad entity with data indicative of pending ad viewings. The ad entity may employ this data to determine how much interest there is in a particular electronic ad and whether his current budget for the electronic ad is sufficient. Unlike current processes, the analysis of unviewed electronic ads provides an ad entity with concrete data reflective of how many individuals are interested in viewing its electronic ads. For example, if an ad entity has allotted for 200 viewings of a particular electronic ad and the ad server 106 indicates that the electronic ad has been viewed 95 times total (via PASS 100 and perhaps other sources), and the analysis of PASS server 108 indicates that its database 210 has 150 potential viewings of the electronic ad, the ad entity may ascertain that its budget might be exceeded by at least 45 viewings. The ad entity may then take appropriate action, such as by increasing its budget for that electronic ad. If the ad entity does not wish to increase its budget to match demand, the ad might be removed from ad server 106 before certain users have had an opportunity to view it. In this case, a user may be notified that the stored electronic ad 208 is no longer available. The user may be informed of this when he attempts to view the stored electronic ad 208 and/or PASS server 108 may notify him via personal information held in his user account 206 (e.g., via an email sent to the user's registered email address).

Although a user may utilize PASS 100 simply for pleasure, he may also be encouraged to participate through various incentive methods, the particulars of which may be stored in one or more incentive records 222. Incentive controller 228 may manage such incentives and track data pertaining to their use. In one embodiment, an incentive for the user may or may not be activated based upon actions he does or does not perform. The user may register one or more financial accounts in association with his user account 206 and may receive financial benefits. For example, an ad entity may compensate the user for displaying its electronic ad advantageously on his PASS display. Alternatively, an ad entity may compensate the user when the user accepts an ad entity's promotion, provides information to the ad entity, provides a recognized benefit to the ad entity, or the like. PASS 100 may facilitate immediate and scheduled transactions using information stored in user account 206 (e.g., financial information, personal information, and/or other information) and the user may be compensated by receiving a monetary payment into a registered financial account. Alternatively, the user may receive other benefits, such as a discount on an advertised product.

Aggregate Information Analysis

PASS 100 may also enable the display and analysis of aggregate information. For example, PASS server 108 may display to users and/or ad entities aggregate statistics and information regarding electronic ads stored for various groups of users or for all users. Aggregate information may also be used to affect how stored electronic ads are displayed to users. For example, electronic ads may be displayed in order of popularity, such as by the number of users who have stored the ad or the number of viewings of an electronic ad. Additionally, PASS 100 may enable incentives based on group decisions (herein referred to as “group incentives”). An individual user may receive an incentive, such as a discount or other special benefit, dependent upon whether a certain number of other users performed one or more actions. Incentive controller 228 may associate a redemption code with the user's user account 206 once the user has performed the necessary action, thereby associating users that are participating in the group incentive. The redemption code may be included in data received when an electronic ad is stored or incentive controller 228 may generate the redemption code. In one scenario, a user need only store the electronic ad in order to participate in the group incentive and receive the redemption code. Alternatively, a user may indicate he desires to participate in a group incentive by clicking a previously stored electronic ad. Alternatively, a redemption code associated with a user account 206 may only be activated once the user has performed a more involved action (e.g., purchased the necessary product) in addition to storing the electronic ad. For example, if a stored electronic ad pertains to a chair and if 10,000 chairs are purchased, each user that has stored the relevant electronic ad may receive a 10% refund. The refund may be credited to a user's registered financial account. In such a scenario, a user may have to indicate to the retailer at the time of purchase that he is a PASS user, such as providing his PASS username or a PASS membership number. The retailer may in turn relay this information to PASS server 108, which may then determine if the redemption code is associated with the appropriate user account 206 and, if so, incentive controller 228 may activate the redemption code. Alternatively, the user may receive a completion code after performing the required action (e.g., on a sales receipt), may access his user account 206 and enter the completion code, thereby activating the redemption code. Group incentive data may be shared with external entities, such as ad entities, so that they may analyze it and determine the quantity of users that have the redemption code associated with their user accounts 206.

In one scenario, a user may request electronic ads from other PASS users or from participating ad entities. For example, the user may access a PASS Web page and enter a query into a search field to determine if any electronic ads stored within the PASS server 108 meet his criteria. For example, a user interested in leasing a vehicle may request ads that provide leasing discounts (e.g., the user may search for a “car lease discount”). The user may then be presented with a result set listing any relevant electronic ads that have been stored by users. PASS server 108 may also relay the query to ad server 106 to determine if ad server 106 has any relevant ads stored within its records and, if so, PASS server 108 may retrieve the relevant ads and display them to the user. Due to the benefits of the ability to request ads, a user may be required to compensate the PASS service provider, other users (e.g., those who stored the requested ad), or ad entities (e.g., those who issued the requested ad). An ad entity or the PASS service provider may compensate a user for sharing ads.

Appointment Ads

One or more components of PASS 100 may enable an electronic appointment ad (herein “appointment ad”). An appointment ad may be an electronic ad that is associated with restricted electronic advertising content, such as information and/or an incentive, that is only available during an appointed time frame, such as during a certain time of day, on a certain date, on a particular day of the week, etc.

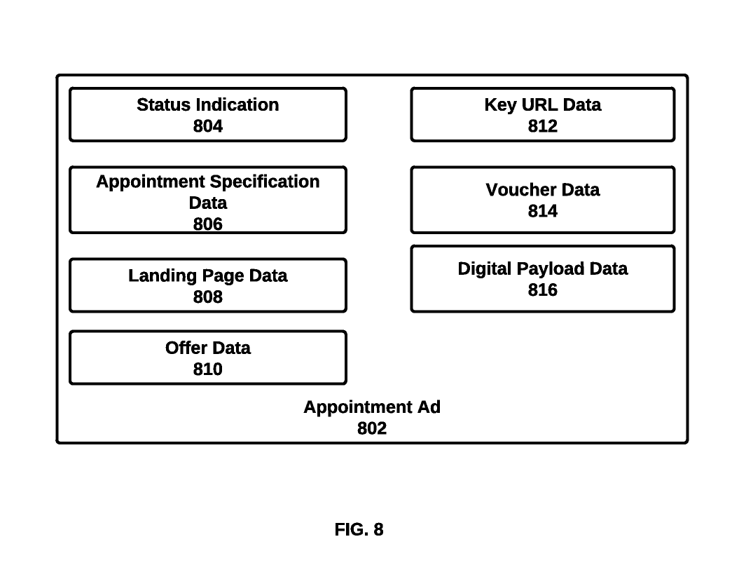

FIG. 8 illustrates a schematic embodiment of appointment ad 802. The components of appointment ad 802 illustrated are logical components and it is to be understood they may be implemented in various fashions, such as computer code, programming, etc. Appointment ad 802 may include ad reference data 808 which may include an ad reference by which ad server 106 and/or PASS server 108 may identify appointment ad 802. Appointment ad 802 may also include status indication data 804 which may enable appointment ad to indicate whether it is active or inactive. Appointment ad 802 may be considered active during an appointed time frame in which appointment ad 802 is enabled to allow access to restricted electronic advertising content. Appointment ad 802 may be considered inactive when it is not enabled to allow access to restricted electronic advertising content. Appointment specification data 806 which interact with ad server 106 and/or PASS server 108, etc. to determine whether the current time is within the appointed time frame and enable to appointment ad 802 to display an appropriate status. For example, appointment specification data 806 may enable appointment ad 802 to display a timer counting down to the appointed time, an active and/or inactive icon, appropriate text regarding whether it is active, etc.

Appointment ad 802 may include data that enables it to provide access to restricted electronic advertising content via ad server 106 and/or PASS server 108 when appointment ad 802 is active. For example, appointment ad 802 may include incentive data 810, key URL data 812, voucher data 814, digital payload data 816, etc., and these may be employed by access mechanism 110, ad server 106, Web site publisher 102, PASS server 108 etc. to provide a user with access to the restricted electronic advertising content. Incentive data 810 may reference an incentive record 222 and managed by an incentive controller 228 and/or may reference incentive data maintained by ad server 106.

When appointment ad 802 is selected while active, access mechanism 110 may display (e.g., via click-thru) the restricted electronic advertising content indicated by the key URL data 812, such a promotional landing page. Key URL data 812 may reference a key URL that is secret or not publicly known. The restricted electronic advertising content referenced by the key URL may be only presented during the appointed time frame. If accessible at another time, other content may load, such as a landing page instructing a user to use appointment ad 802, explaining that the content is not available, etc. Because the key URL may only be accessible via appointment ad 802, users may be purposefully hindered from accessing the landing page from sources other appointment ad 802. Access to the key URL may be restricted to a limited number of accesses (e.g., one access) and the number of accesses may be determined by session tracking, tracking cookies, etc. The key URL may be designed so that it may not be easily copied and/or shared. An element of the key URL may be randomly generated by ad server 106 and/or PASS server 108 when appointment ad 802 is active. In one scenario, the key URL, or an element of it, may be purged from access mechanism 110 after a user has accessed the restricted electronic advertising content. Additionally, or alternatively, to prevent a user from accessing the key URL directly (e.g., entering the key URL in the address bar of a web browser), the landing page associated with the key URL may require a user provide a code included in appointment ad 802 to access the restricted electronic advertising content. For example, appointment ad 802 may read “enter the code word “WINNER” to receive your 50% off!” and the landing page associated with the key URL may include an input field in which the user may enter this code.

If the restricted electronic advertising content includes a voucher indicated by voucher data 814, the voucher may be electronic or printable and the user may present it to a participating vendor in order to redeem the associated incentive.

Appointment ad 802 may also be associated with unrestricted electronic advertising content that may be presented if appointment ad 802 is selected while inactive. For example, appointment ad 802 may include landing page data 808 (e.g., a URL) that indicates a public Web page associated with an advertised product. The landing page may inform the user of when the restricted electronic advertising content will be available, that it is no longer available, advertise another product, etc.

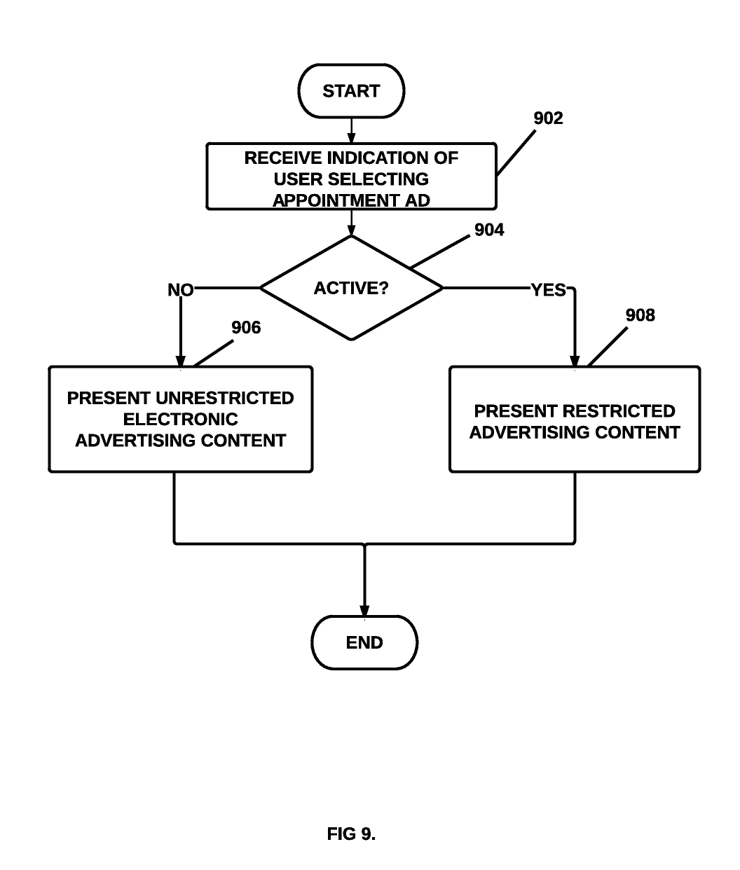

FIG. 9. illustrates a flowchart of an embodiment of a process for accessing electronic advertising content via an appointment ad. When a user selects an appointment ad, ad server 106 and/or PASS sever 108 may receive an indication of the selection (step 902) and may determine if the appointment ad is active (step 904). Ad server 106 and/or PASS server 108 may employ an ad reference associated with the selected appointment ad to access electronic ad data stored at ad server 106 and/or PASS server 108 and determine whether the user's selection of the appointment ad has occurred during the appointed time frame.

If the appointment ad has been selected while the appointment ad is inactive, the appointment ad may enable the presentation of unrestricted electronic advertising content indicated by the stored electronic ad data (step 906). An inactive appointment ad may display electronic advertising content outside of the specified time frame, but may do so in a limited fashion (e.g., not provide full details of an incentive, not allow access to a promotional landing page, etc.). While inactive, the appointment ad may serve as a placeholder and/or reminder that a particular promotion is upcoming or has already occurred and/or may direct users to a landing page (e.g., as indicated by landing page data 808) that may provide information about a promoted product. For example, if a user selects the appointment ad outside of the appointed time frame, nothing may happen, the appointment ad may present a message reminding the user that the promotion is not active yet, the user may be presented with an associated landing page, but not be given access to a restricted promotion, etc.

If the appointment ad is active, the user may be presented with restricted electronic advertising content indicated by the stored electronic ad data (step 908). The restricted electronic advertising content may be displayed via access mechanism 110 navigating to a new electronic location or the display of the appointment ad may change to present the restricted electronic advertising content. In one embodiment, instead of, or in addition to, the user selecting the appointment ad while it is active to access the restricted content, the appointment ad may be configured to display the restricted electronic advertising content at the appointed time without the user selecting it.

To account and track views of appointment ads, ad server 106 and/or PASS server 108 may not track views except when an appointment ad is viewed while active or may account for active and inactive viewings differently.

As an appointment ad is an electronic ad, one or more components of PASS 100 may be used to enable the storing, sharing, viewing, management, accounting, and analysis of appointment ads, as previously described. As user may configure his user account 206 so that PASS server 108 notifies him of an ad's appointed time frame. For example, a user may opt to receive an email or text message notification when an appointment ad is about to become active. When a user accesses a stored electronic appointment ad 802 outside of its active time frame, he may only view the electronic advertising content that is available during this inactive time. When the user accesses the stored appointment ad 803 during its active time, he may interact with it as an active ad. For example, a user may select the stored appointment ad 802 and be presented with electronic advertising content only available during this time frame, be taken to the promotional landing page, etc. If presentation of the stored appointment ad 802 is handled in a fashion similar to an electronic ad displayed at a Web page, ad server 106 may treat the viewing in the same manner as an ad presented on a standard Web page (e.g., only allowing access to the landing page during the appointed time frame, only tracking the viewing if it is during the appointed time frame, etc.). If all of the data necessary for displaying the stored appointment ad 802 has been stored at PASS server 108, PASS server 108 may restrict viewing to the appointed time frame and may maintain a viewing log for viewings of the ad only during the appointed time frame. If the display of the stored appointment ad 802 requires PASS server 108 to serve as an intermediary between access mechanism 110 and ad sever 106, one or more of PASS server 108 and ad server 106 may restrict and track the viewing during the appointed time frame.

As aforementioned, although the present invention has been described mainly in terms of Internet usage, this is not to be construed as limiting. For example, PASS 100 may be employed via an interactive television system or mobile network. A PASS icon may be displayed when a television ad is presented and the user may employ the “select” button on his television remote to store the ad to his user account 206. Alternatively, without a PASS icon, another indicator or no indicator may be used. The user may later use the interactive television to access his user account 206 and view the ad. Within a mobile network, the PASS icon may be displayed graphically with an advertisement or as text and the user may select the icon or text for storage of the electronic ad. An electronic ad may have an audio indicator instead of or in addition to a visual icon. Voice commands may be used for interacting with the electronic ad. For example, the user may speak “save the ad” into a microphone to have the electronic ad stored to his user account 206.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the description should not be considered to be exclusive of these other embodiments. Also, it is to be understood that the phraseology and terminology employed herein are for the purposes of description and should not be regarded as limiting.

1. A system for the processing of electronic ads in an electronic network, the system comprising:
a server configured to:
store data pertaining to an electronic ad associated with an incentive available during an appointed time frame; and
determine based on the current time and the stored data pertaining to the electronic ad, whether to enable presentation of the incentive associated with the electronic ad to a user via an access mechanism, whereby a user who selects the electronic ad gains access to the incentive only during the appointed time frame.

2. The system of claim 1, wherein the server is an ad server.

3. The system of claim 1, wherein the server is a personal ad storage server.

4. The system of claim 1, wherein the server is configured to interact with an access mechanism via an electronic network.

5. The system of claim 4, wherein the electronic network is one of the following: the Internet, a mobile network, or a broadcast network.

6. The system of claim 4, wherein the access mechanism is configured to enable the viewing of information and the inputting of information and is associated with one of the following: a personal computer, a mobile phone, a personal digital assistant, a multipurpose mobile device, a television, or a kiosk.

7. The system of claim 1, wherein the electronic ad is configured to enable the storage of the electronic ad at the server with minimal manual human action.

8. The system of claim 1, wherein the server is configured to store the incentive, wherein the incentive includes data associated with the distribution of the incentive to the user.

9. The system of claim 1, wherein the server is configured to store a relationship record, wherein the relationship record maintains data reflective of a relationship between one or more of a first user and a first ad entity with one or more of a second user and a second ad entity.

10. A method for enabling the presentation of electronic advertising content during an appointed time frame, the method comprising:
receiving, at a server from an access mechanism, a request to access electronic advertising content associated with an electronic ad, wherein the request indicates electronic ad data stored by the server and wherein the electronic advertising content is accessible only during an appointed time frame;
locating, by the server, the stored electronic ad data;
determining, by the server, whether the request to access the electronic advertising content occurred during the appointed time frame; and
if the request to access the electronic advertising content occurred within the appointed time frame, enabling the access mechanism to access the electronic advertising content, thereby enabling the access mechanism to present the electronic advertising content to a user.

11. The method of claim 10, wherein the server is an ad server and the electronic ad was stored at the server by an ad entity.

12. The method of claim 10, wherein the server is a personal ad storage server and the electronic ad was stored at the server by the user.

13. The method of claim 12, wherein the stored electronic ad data includes an ad identifier that indicates an ad server storing the electronic advertising content.

14. The method of claim 13, wherein enabling the access mechanism to access the electronic advertising content comprises:
transmitting an ad identifier to the access mechanism, thereby enabling the access mechanism to:
access the ad server;
receive from the ad server the electronic advertising content indicated by the ad identifier; and
present the electronic advertising content.

15. The method of claim 13, wherein enabling the access mechanism to access the electronic advertising content comprises:
retrieving, by the personal ad storage server from the ad server, the electronic advertising content indicated by an ad identifier; and
transmitting the retrieved electronic advertising content to the access mechanism.

16. The method of claim 12, wherein the electronic advertising content is stored by the personal ad storage server.

17. The method of claim 10, further comprising recording by the server in a viewing log that the electronic advertising content has been accessed.

18. The method of claim 17, further comprising enabling by the server access to the viewing log data to an authorized entity.

19. A method for storing an appointment-based electronic ad via an electronic ad storage system, the method comprising:
receiving, at a personal ad storage server from an access mechanism operated by a user, a request to store an electronic ad, wherein the electronic ad is associated with electronic advertising content available during an appointed time frame and wherein the electronic ad has been enabled for to be stored at the personal ad storage server;
determining whether the request from the access mechanism indicates that the user has been authenticated; and
if the user has been authenticated, the personal ad storage server stores data associated with the electronic ad in a user account associated with the user, thereby enabling the retrieval of the electronic ad at a later time, including enabling the retrieval of the electronic advertising content available during the appointed time frame;
if the user has not been authenticated the personal ad storage server, the personal ad storage server:
stores data associated with the electronic ad in a temporary account; and
transmits a unique identifier to the access mechanism, wherein the unique identifier enables the retrieval of the electronic ad at a later time, including enabling the retrieval of the electronic advertising content available during the appointed time frame.

20. The method of claim 19, wherein the user account is maintained by one or more the following: the personal ad storage server and a social networking service.
